(19) United States
(12) Patent Application Publication
(10) Pub. No.: US 2012/0236586 A1
(43) Pub. Date: Sep. 20, 2012

(54) LED LIGHT GUIDE STRUCTURE

(75) Inventor: Chin-Wen WANG, Pingzhen City (TW)

(73) Assignees: Ching-Chung Wang; Chin-Wen Wang

(21) Appl. No.: 13/048,016

(22) Filed: Mar. 15, 2011

(51) Int. Cl. F21V 13/02; F21V 29/00; F21V 13/12

(52) U.S. Cl. 362/555

(57) ABSTRACT

A light guide structure using an LED as a light source includes a refracting base, an LED light source module, and an optical fiber tube. The refracting base has a hollow chamber with a wall in a shape without any acute angle, and the LED light source module is fixed onto the refracting base, and the LED light source module includes an LED installed in the hollow chamber. One end of the optical fiber tube is disposed in the hollow chamber, and the other end of the optical fiber tube is extended out of the refracting base. Therefore, the invention can increase the number of reflections of the light inside the hollow chamber and reduce the loss of light occurred during the refraction process to provide a lamp with good illumination.

### FIELD OF THE INVENTION

The present invention relates to a light emitting diode (LED) lamp, in particular to an LED light guide structure.

### BACKGROUND OF THE INVENTION

Light emitting diode (LED) has the advantages of low power consumption, excellent power saving effect, long life, small volume and quick response, so that it gradually replaces conventional light bulbs and is used extensively in various types of light emitting devices. Since the LED is a point light source, and practical applications generally integrate a plurality of LEDs into a light emitting module and then install the light emitting module in a lamp holder with a reflective surface for collecting the light emitted by the LEDs in order to increase the illumination surface of the LED.

In addition, a single LED can be used as a light emitting module of a light source. After a light emitted from the LED is reflected, the light can be outputted through the channel of an optical fiber and used for illumination. However, such structure has the following drawbacks in its application. The light emitted from the LED is reflected and then outputted through the optical fiber, and thus the light emitted from the LED is limited by the refractive surface, which allows a limited number of the refractions only. If acute angles are formed on the refractive surface, a significant loss of light may occur easily during the refraction process, and the brightness of the light outputted from the LED light source will become low and insufficient. As a result, the single LED fails to be a good light emitting module.

In view of the aforementioned drawbacks, the inventor of the present invention based on years of experience in the related industry to conduct extensive researches and experiments, and finally developed an LED light guide structure in accordance with the present invention to overcome the drawbacks of the prior art.

### SUMMARY OF THE INVENTION

Therefore, it is a primary objective of the present invention to provide an LED light guide structure to increase the number of the light reflections, reduce the loss of light occurred during the light refraction process, and provide a lamp with good illumination.

To achieve the foregoing objective, the present invention provides an LED light guide structure, comprising a refracting base, an LED light source module, and an optical fiber tube, wherein the refracting base has a hollow chamber with a wall in a shape without any acute angle; the LED light source module is fixed onto the refracting base and includes an LED installed in the hollow chamber; and the optical fiber tube has one end disposed in the hollow chamber and the other end extended out of the refracting base.

Another objective of the present invention is to provide an LED light guide structure that can adjust the brightness of illumination according to actual requirements and provide an easy management and maintenance.

Compared with the prior art, the LED light guide structure of the present invention has the refracting base with the hollow chamber. Since the wall of the hollow chamber is in the shape without any acute angle, therefore the light inside the hollow chamber can be reflected for several times without causing a loss of light, and a vast majority of the light produced by the LED light source module can be reflected to the optical fiber tube for the use of illumination. In addition, the light source module of the present invention is installed on the refracting base, and the optical fiber tube is installed as required to guide the light source to a place wherein illumination is required. Since the light source module is collected and concentrated at a position, therefore the management and maintenance will become easy. Further, the present invention can install a plurality of LED light source modules on the refracting base as required to enhance the brightness of the illumination.

### BRIEF DESCRIPTION OF THE DRAWINGS

FIG. 1 is an exploded view of an LED light guide structure in accordance with a first preferred embodiment of the present invention;

FIG. 2 is a perspective view of an LED light guide structure in accordance with a first preferred embodiment of the present invention;

FIG. 3 is a cross-sectional view of an LED light guide structure in accordance with a first preferred embodiment of the present invention;

FIG. 4 is a schematic view of using an assembled LED light guide structure in accordance with a first preferred embodiment of the present invention;

FIG. 5 is a schematic view of an LED light guide structure in accordance with a second preferred embodiment of the present invention; and

FIG. 6 is a schematic view of an LED light guide structure in accordance with a third preferred embodiment of the present invention.

### DESCRIPTION OF THE PREFERRED EMBODIMENTS

The technical characteristics and contents of the present invention will become apparent with the following detailed description and related drawings. The drawings are provided for the purpose of illustrating the present invention only, but not intended for limiting the scope of the invention.

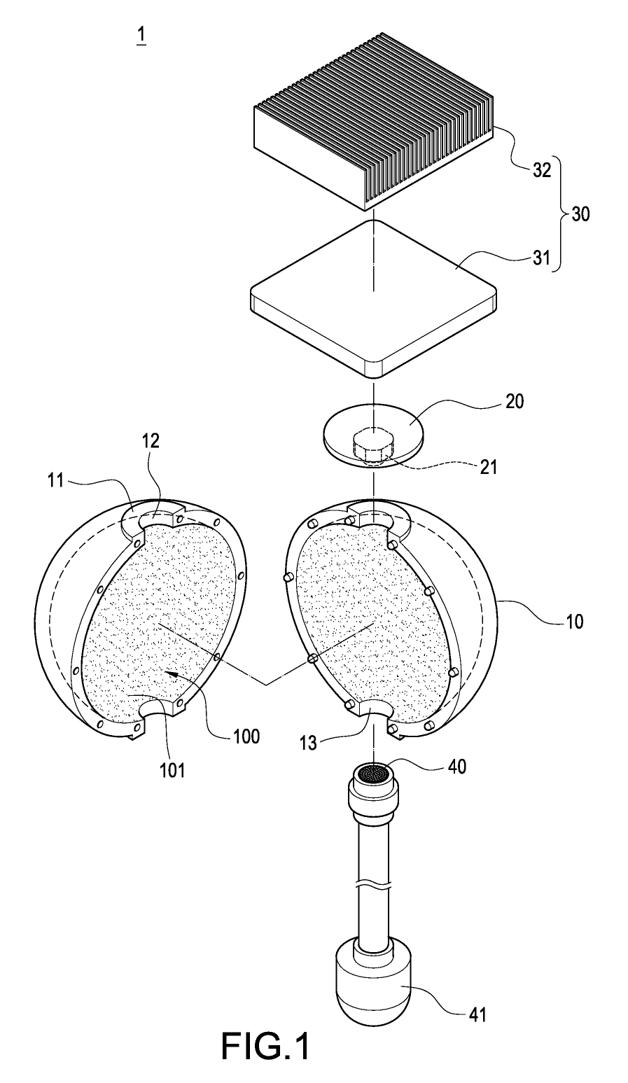

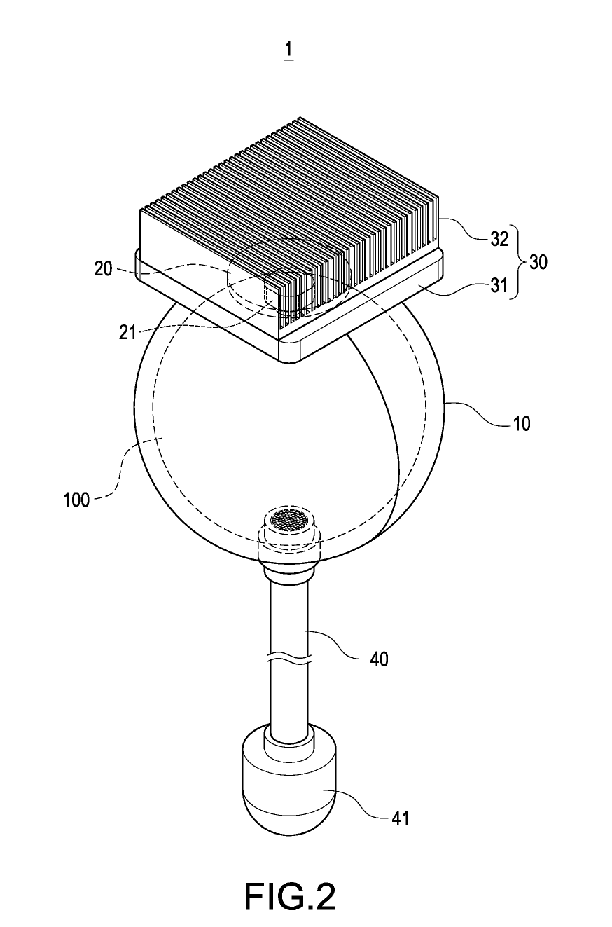

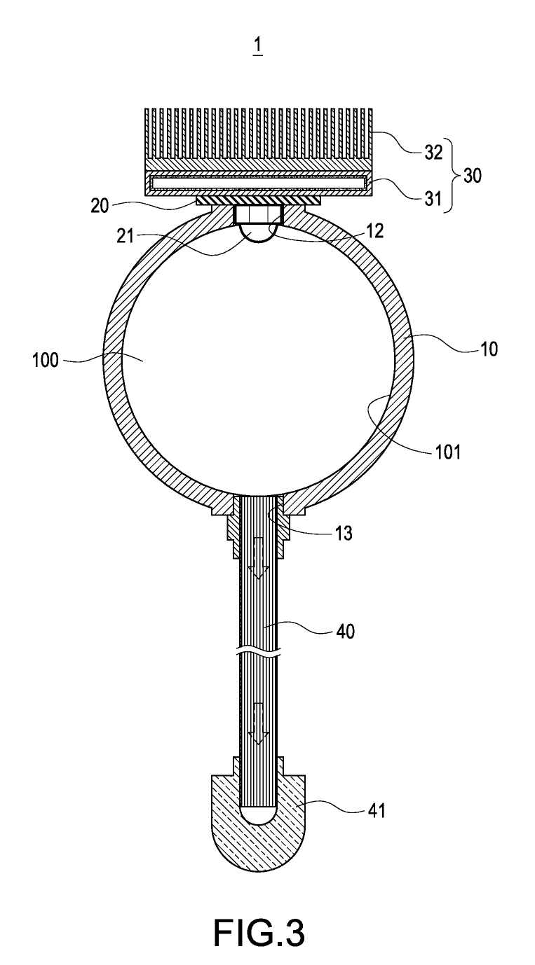

With reference to FIGS. 1 to 3 for an exploded view, a perspective view and a cross-sectional view of an LED light guide structure in accordance with a first preferred embodiment of the present invention respectively, the LED light guide structure 1 comprises a refracting base 10, at least one LED light source module 20, a heat dissipating member 30 and an optical fiber tube 40.

The refracting base 10 has a hollow chamber 100 with a wall in shape without any acute angle for increasing the number of reflections of the light inside the hollow chamber 100 and reducing the loss of light occurred during the refraction process. In this preferred embodiment, the wall of the hollow chamber 100 is in a camber shape, but the practical application of the present invention is not limited to this shape only. In addition, the wall of the hollow chamber 100 can be electroplated with a highly reflective material 101 (such as gold, silver and chromium, etc) to enhance the reflective index of the hollow chamber 100. It is noteworthy to point out that the refracting base 10 of this preferred embodiment is substantially in a spherical shape, but the invention is not limited to this shape only. In addition, the refractive base 10 is comprised of two hemispherical shells and includes an installation platform 11. The installation platform 11 has a light inlet 12, and the refracting base 10 has a light outlet 13 formed on an opposite side of the light inlet 12.

The LED light source module 20 is fixed onto the refracting base 10 and includes an LED 21 installed in the hollow chamber. In this preferred embodiment, the LED light source module 20 is installed on the installation platform 11 of the refracting base 10, and the LED 21 is protruded through the light inlet 12 into the hollow chamber 100.

The heat dissipating member 30 is thermally coupled to the LED light source module 20 for dissipating the heat generated by the LED light source module 20. The shape of the heat dissipating member 30 is not limited, and the heat dissipating member 30 of this preferred embodiment includes a vapor chamber 31 and a set of heat dissipating fins 32, wherein the vapor chamber 31 is attached to the LED light source module 20, and the set of heat dissipating fins 32 are installed on the vapor chamber 31, such that the heat generated by the LED light source module 20 can be conducted through the vapor chamber 31 to the set of heat dissipating fins 32, and then dissipated from the set of heat dissipating fins 32 quickly.

The optical fiber tube 40 is passed into the light outlet 13, and one end of the optical fiber tube 40 is disposed in the hollow chamber 100, and the other end coupled with a lens 41 is extended out of the refracting base 10.

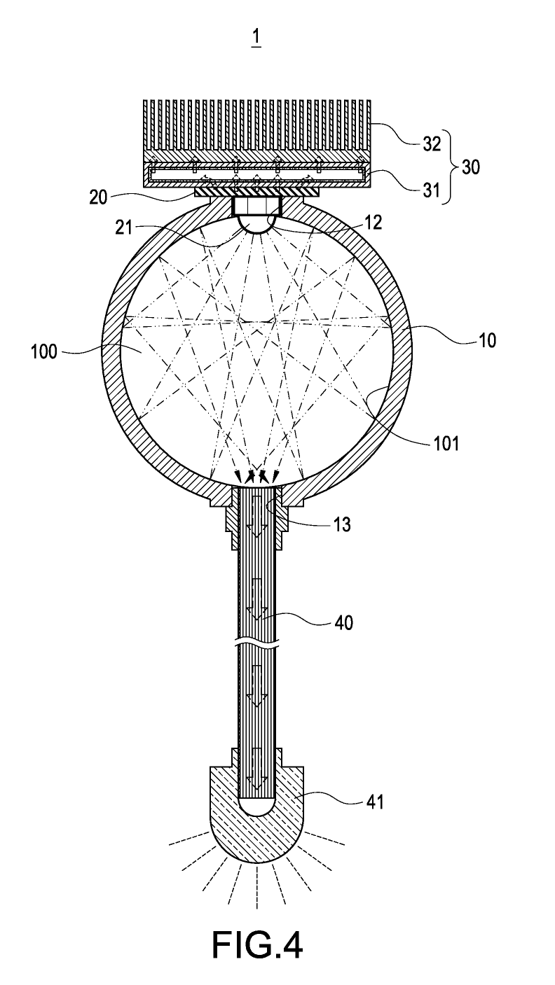

With reference to FIG. 4 for a schematic view of using an LED light guide structure of the present invention, the light emitted from the LED 21 of the LED light source module 20 is reflected from the wall of the hollow chamber 100 to the optical fiber tube 40, and then guided by the optical fiber tube 40 for illumination. Since the wall of the hollow chamber 100 is in the shape without any acute angle, therefore the light can be reflected for several times in the hollow chamber 100, and the light will not be lost easily. In addition, a vast majority of the light produced by the LED light source module 20 is reflected to the optical fiber tube 40, and the lens of the optical fiber tube 40 is provided for increasing the illumination area for the illumination.

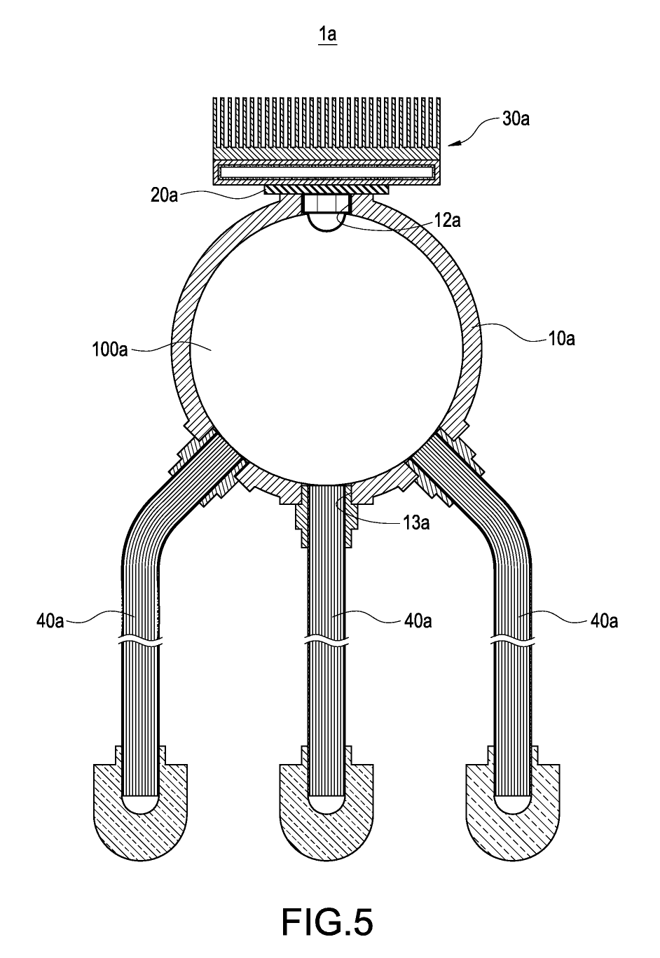

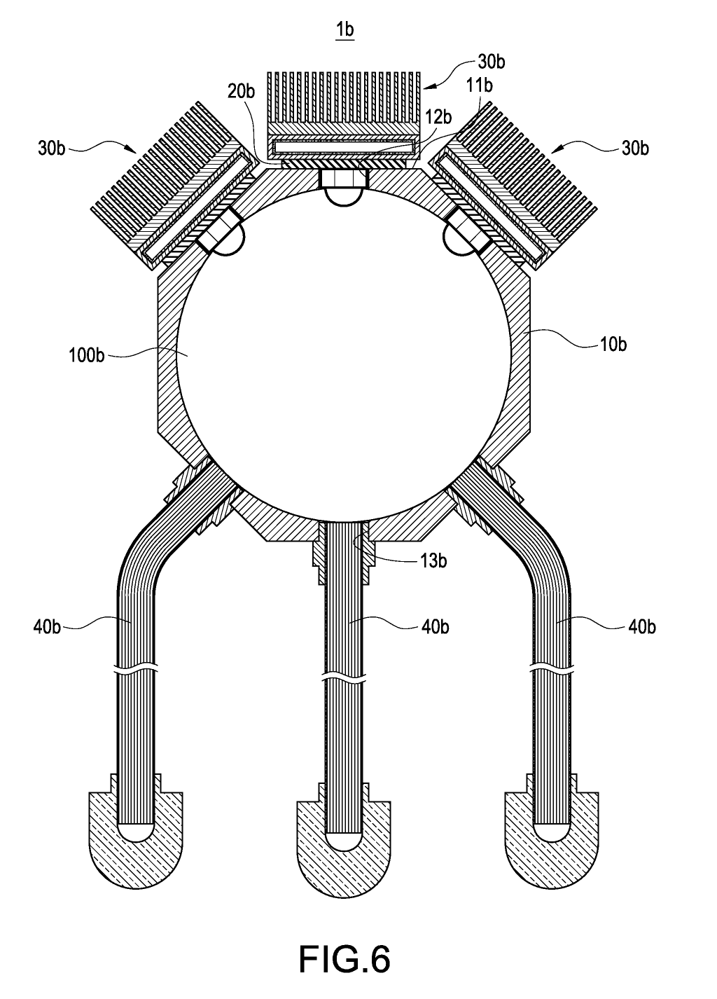

With reference to FIGS. 5 and 6 for the LED light guide structures in accordance to the second and third preferred embodiments of the present invention respectively, the LED light guide structure 1a as shown in FIG. 5 is substantially the same as that of the first preferred embodiment, and the LED light guide structure 1a comprises a refracting base 10a installed on the LED light source module 20a of the refracting base 10a, and the difference of the heat dissipating member 30a and the optical fiber tube 40a of the second preferred embodiment from those of the first preferred embodiment resides on that the refracting base 10a of the second preferred embodiment has a plurality of light outlets 13a formed on an opposite side of the light inlet 12a, and each light outlet 13a is installed with an optical fiber tube 40a, and an end of each optical fiber tube 40 is disposed in the hollow chamber 100a.

In FIG. 6, the difference between the LED light guide structure 1b of the third preferred embodiment and the LED light guide structure 1a of the second preferred embodiment resides on that the refracting base 10b is in a polygonal cylindrical shape, and the LED light source module 20b comes with a plural quantity. The refracting base 10b has a plurality of installation platforms 11b formed thereon, and each installation platform 11b has a light inlet 12b, and each LED light source module 20b is installed on the installation platform 11b, and the LED 21b of the LED light source module 20b is protruded through the light inlet 12b into the hollow chamber 100b. Further, the refracting base 10b also has a plurality of light outlets 13b formed on an opposite side of the light inlets 12a.

While the invention has been described by means of specific embodiments, numerous modifications and variations could be made thereto by those skilled in the art without departing from the scope and spirit of the invention set forth in the claims.

What is claimed is:

1. A light emitting diode (LED) light guide structure, comprising:
a refracting base, having a hollow chamber with a wall in a shape without any acute angle;
at least one LED light source module, fixed onto the refracting base, and including an LED installed in the hollow chamber; and
an optical fiber tube, with one end disposed in the hollow chamber, and the other end extended out of the refracting base.

2. The LED light guide structure of claim 1, wherein the refracting base is comprised of two hemispherical shells.

3. The LED light guide structure of claim 1, wherein the refracting base has an installation platform formed thereon, and the installation platform has a light inlet, and the LED light source module is installed on the installation platform, and the LED is protruded through the light inlet into the hollow chamber.

4. The LED light guide structure of claim 3, wherein the refracting base has a light outlet, and the optical fiber tube is passed into the light outlet.

5. The LED light guide structure of claim 3, wherein the refracting base has a plurality of light outlets formed on an opposite side of the light inlets.

6. The LED light guide structure of claim 1, wherein the LED light source module comes with a plural quantity, and the refracting base has a plurality of installation platforms formed thereon, and each installation platform has a light inlet, and each LED light source module is installed on the respective installation platform, and the LED is protruded through the light inlet into the hollow chamber.

7. The LED light guide structure of claim 6, wherein the refracting base has a plurality of light outlets formed on an opposite side of the light inlets.

8. The LED light guide structure of claim 1, wherein the refracting base is substantially in a spherical shape.

9. The LED light guide structure of claim 1, wherein the refracting base is substantially in a polygonal cylindrical shape.

10. The LED light guide structure of claim 1, wherein the wall of the hollow chamber is electroplated with a highly reflective material.

11. The LED light guide structure of claim 1, wherein the wall of the hollow chamber is in a camber shape.

12. The LED light guide structure of claim 1, further comprising a heat dissipating member thermally coupled to the LED light source module.

13. The LED light guide structure of claim 12, wherein the heat dissipating member includes a vapor chamber attached to the LED light source module.

14. The LED light guide structure of claim 13, wherein the heat dissipating member further includes a set of heat dissipating fins installed on the vapor chamber.

15. The LED light guide structure of claim 1, wherein the optical fiber tube has a lens coupled to an end of the optical fiber tube.
